(19) United States
(12) Patent Application Publication
(10) Pub. No.: US 2019/0184648 A1
(43) Pub. Date: Jun. 20, 2019

(54) Faserverbund-Bauteilanordnung, Faserverbund-Bauteilsystem und Verfahren zum Herstellen eines Faserverbund-Bauteilsystems

(71) Applicant: MTU Aero Engines AG, Muenchen (DE)

(72) Inventor: Alexander BOECK, Kottgeisering (DE)

(21) Appl. No.: 16/211,474

(22) Filed: Dec. 6, 2018

(30) Foreign Application Priority Data
Dec. 15, 2017 (DE) DE102017222897.0

(51) Int. Cl. B29C 65/00; B29C 65/52

(52) U.S. Cl. CPC B29C 66/0224; B29C 65/522; B29C 66/742; B29C 66/43; B29C 66/721; B29C 66/1122

(57) ABSTRACT

A fiber composite component assembly (100) includes a fiber composite component (3) including a base material and a fiber material, and a tolerance compensation layer (5) for joining the fiber composite component (3) to a further component (1), the tolerance compensation layer (5) including a fiber composite portion (17) and/or a further layer portion (7). A fiber composite component system (200) including a fiber composite component assembly (100) and a further component (1) joined to the fiber composite component assembly (100), as well as a method for producing a fiber composite component system (200), is also provided.

This claims the benefit of German Patent Application DE 102017222897.0, filed Dec. 15, 2017 and hereby incorporated by reference herein.

The present invention relates to a fiber composite component assembly including a fiber composite component and a tolerance compensation layer. The present invention also relates to a fiber composite component system, as well as a method for producing a fiber composite component system.

### BACKGROUND

In practice, fiber composite materials are used for different applications and in different fields. However, the process steps and production techniques for producing components using fiber composite materials are not yet as standardized and fully developed as in the case of other materials, such as metals, polymers and ceramics. Depending on the manufacturing method used for processing fiber composite materials, fiber composite components may have uneven surfaces on one or both sides of the fabricated components. When these uneven surfaces are to be joined to one another or to other mechanically machined components in a subsequent processing step, these uneven surfaces may not lie flat against each other. Depending on the application, this may lead to damage and/or leakage of the mounted component. The connections may be form-fitting connections, force-fit connections and/or material-to-material bonds such, as, for example, threaded or riveted connections. To prevent such damage and/or leakage, it may be necessary to machine uneven surfaces on the fiber composite components mechanically; for example by milling. Mechanical machining of fiber composite components may, however, cause subsurface fibers to be partially cut. These partial cuts may lead to structural weakening of the components.

### SUMMARY OF THE INVENTION

It is an object of the present invention to provide a fiber composite component assembly that is improved with respect to the problems described. Another object of the present invention is to provide a fiber composite component system as well as a method for producing a fiber composite component system.

In accordance with the present invention, there is provided a fiber composite component assembly including a fiber composite component and a tolerance compensation layer for joining the fiber composite component to a further component. The fiber composite component includes at least one base material and one fiber material. Furthermore, the tolerance compensation layer includes a fiber composite portion and a further layer portion. Alternatively, the tolerance compensation layer includes a fiber composite portion or a further layer portion.

The fiber composite component system according to the present invention includes a fiber composite component assembly according to the present invention and a further component which is joined to the fiber composite component assembly.

The method according to the present invention for producing a fiber composite component system according to the present invention includes at least the following steps. First, a fiber composite component assembly according to the present invention is provided. Then, the tolerance compensation layer of the fiber composite component assembly is machined. This machining is performed in such a manner that the surface contour of the to-be-joined surface of the further component is adapted to the surface of the tolerance compensation layer. Such machining may consist in creating a substantially planar surface of the tolerance compensation layer, for example by chip-removing machining of the surface, if the opposite side of the joint is also a substantially planar surface. The last step of the method is to join the fiber composite component assembly to the further component by means of the adapted tolerance compensation layer, in particular using a joining process. A joining process may be or include adhesive bonding. Optionally, the surfaces may be pre-treated prior to an adhesive bonding step, for example by means of a plasma process, so as to clean the surfaces of production aids, such as release agents or lubricants.

Advantageous refinements of the present invention are the subject matter of the respective specific embodiments.

Specific exemplary embodiments of the present invention may include one or more of the features set forth below in any combination unless a, or the, particular combination is readily understood by the skilled person to be technically impossible. Specific exemplary embodiments of the present invention are also defined by the respective subject matters of the dependent claims.

In all of the above and following discussion, the expressions “may be,” respectively “may have,” etc., will be understood to be synonymous with “is preferably,” respectively “preferably has,” etc., and are intended to illustrate specific exemplary embodiments of the present invention.

Whenever alternatives are introduced with “and/or” herein, the “or” contained therein is preferably understood by the skilled person as “either or” and preferably not as “and.”

The specific embodiments set forth herein are to be understood as inventive, merely exemplary embodiments of the present invention and are not meant to be limiting.

A fiber composite component is in particular a component that is made from a fiber composite material or includes a fiber composite material. A fiber composite material may consist of, or include, two main constituents. Optionally, the fiber composite material may include further constituents. The first main constituent may be referred to as base material or as matrix or as embedding matrix. The second main constituent may be referred to as fiber material, fibers or as reinforcing fibers. The fiber composite material may be referred to as multi-phase material or as mixed material. Due to mutual interactions of the constituents, in particular of the two main constituents, the fiber composite material may have special or specific or improved properties over the individual constituents involved. For example, the specific strength of the fiber composite component may be increased by means of very thin fibers with diameters in the range of a few μm. In the fiber direction, a fiber composite material may have a strength many times greater than that of the base material. Furthermore, the fibers in the fiber composite material may be oriented and adapted in terms of density (number per unit area) in accordance with the later direction of loading. Therefore, it is possible to produce customized components using suitable manufacturing methods. To control strength in different directions, woven fabrics or unidirectional fabrics may be used instead of individual fibers. Such fabrics may be produced prior to contact with the matrix.

A fiber composite material may, merely by way of example, include a polymer matrix, a metal matrix and/or a ceramic matrix.

A tolerance compensation layer may be a layer that compensates for irregularities in a surface, for example in undulated surfaces. For example, components, in particular components containing fiber composite materials, may have irregularities, warps, deformations, or the like, due to the manufacturing process. Such deformations may be caused by different materials in the component. In certain manufacturing temperature ranges, humidity ranges, etc., different materials may have different deformation properties, different expansion properties, etc., and lead to such deformations. If the component includes a fiber-reinforced material, direct mechanical machining of the deformed component in order to compensate for and/or level deformations could have a negative effect on the strength of the component. The subsurface fibers could be damaged or cut into individual fiber segments by the mechanical machining, so that the structural integrity of the strength-enhancing fiber structures at least partially no longer exists. Therefore, the fiber composite component assembly according to the present invention includes a tolerance compensation layer which may be applied or attached to the fiber composite component to compensate for the deformations. Mechanical machining of the tolerance compensation layer instead of a direct mechanical machining of the fiber composite component advantageously does not result in damage to or disruption of the structural integrity of the underlying fiber structures. Thus, by mechanically machining the tolerance compensation layer, the deformed component may be machined for joining the fiber composite component to a further component.

Machining may be done mechanically and/or subtractively; i.e. by removal of material, for example by milling and/or grinding, or may include such type of machining, in particular to provide a plane joining surface on the machined tolerance compensation layer.

The tolerance compensation layer may be referred to as intermediate layer.

In some specific embodiments, the tolerance compensation layer includes a fiber composite portion.

The fiber composite portion may be a portion that is made from a fiber composite material or includes a fiber composite material. The fiber composite portion may include the same base material as the fiber composite component. Alternatively, the fiber composite portion may include another base material that is different from the base material of the fiber composite component. The fiber composite portion may include the same fiber material as the fiber composite component. Alternatively, the fiber composite portion may include another fiber material that is different from the fiber material of the fiber composite component.

A fiber composite portion may be a layer, a ply, a component portion, a shoulder, or the like.

In some specific embodiments, the tolerance compensation layer includes a further layer portion. The further layer portion may include the same base material as the fiber composite component and/or the same base material as an optional fiber composite portion. The further layer portion may include a different base material than the fiber composite component and/or a different base material than the optional fiber composite portion. The further optional layer portion may be made from or include a polymer, a composite material or a different material.

The fiber composite component and the tolerance compensation layer may include the same base material, at least in some regions. The base materials of the fiber composite component and of the tolerance compensation layer may be integrally joined together, at least in some regions. An integral construction may be referred to as a one-piece type of construction. An integral construction is based, for example, on an injection-molding process or a generative manufacturing process. Alternatively, the base material of the tolerance compensation layer may be joined to the fiber composite component, in particular by material-to-material bonding, such as by adhesive bonding.

The tolerance compensation layer may include a fiber material which, at least in some regions, is the same fiber material as that of the fiber composite component.

The structural unit of the fiber composite component and the structural unit of the fiber composite portion of the tolerance compensation layer may be different. A structural unit of the fiber composite component may be considered to be a unit that exhibits a uniform fiber structure. A uniform fiber structure may have, for example, fiber orientations or fiber plies of woven fabrics or stitched fabrics which are not characterized by individual fiber segments or by shortened or cut fibers. Due to this uniform fiber structure, a uniform fiber structure exhibits high strength. In the case of a non-uniform fiber structure, this strength is reduced. In the case that the structural unit of the fiber composite component, on the one hand, and the structural unit of the fiber composite portion of the tolerance compensation layer, on the other hand, are different, the strength of the entire unit consisting of the fiber composite component and the fiber composite portion of the tolerance compensation layer is reduced as compared to a non-different; i.e., uniform structural unit. For example, the fiber composite portion of the tolerance compensation layer has separate fibers and cut fibers in the end regions of the fiber composite portion, which fibers do not form a unit with the fibers of the fiber composite component.

The fiber composite component and the tolerance compensation layer may be integrally joined together, at least in some regions.

The further layer portion may be a sprayed layer or include a sprayed layer. A sprayed layer may be a polymer layer or ceramic layer applied to a base layer using a spraying process or plasma spraying process. By means of a sprayed layer, it is possible to create a material-to-material bond between the applied sprayed layer and the base layer. The base layer may be the fiber composite portion of the tolerance compensation layer and/or the fiber composite component.

The further layer portion may be joined to the fiber composite portion by a material-to-material bond, at least in some regions. Alternatively or additionally, the further layer portion may be joined to the fiber composite component by a material-to-material bond, at least in some regions.

The thickness of the tolerance compensation layer may be greater than the maximum profile depth of surface irregularities of the fiber composite component. In the case of an exemplary, wavy surface of the fiber composite component, the maximum profile depth may be defined as the maximum depression in the wavy surface shape, considered in a direction perpendicular to the surface. The thickness of the tolerance compensation layer may lead to a continuous, smooth and even shape of the tolerance compensation layer, without individual surface regions of the tolerance compensation layer being regions of the fiber composite component. This advantageously allows the tolerance compensation layer to be machined, for example by grinding and/or polishing, without damaging or disrupting the fiber structure of the fiber composite component. The surface of the tolerance compensation layer could also be machined by milling, provided the milling depth does not reach or cause damage to the surface of the fiber composite component.

Merely by way of example, the fiber composite component assembly according to the present invention makes it possible to obtain what is referred to as a precision surface for joining the fiber composite component to a further component which has, for example, a metallic smooth surface. This precision surface may be dense in terms of surface structure; i.e., may not have any irregularities, steps, defects, microholes etc. Furthermore, it may be achieved that the precision surface does not generate any internal stresses when the fiber composite component is clamped to a further component. This precision surface may be obtained by a combination of integrally producing a fiber composite portion of the tolerance compensation layer, at least in some regions, and subsequently applying a further, in particular thin, layer portion, for example a sprayed layer. The precision surface may be produced by the two machining steps described below. In the first machining step, in particular by mechanical machining of the integral part; i.e., of the fiber composite portion of the tolerance compensation layer, tolerance compensation is achieved for the irregularities of the fiber composite component. In the second machining step, the, in particular thin, further layer portion is machined to very high dimensional accuracy with regard to surface finish, for example with regard to a very smooth and even surface. The second machining step may include grinding and polishing. Depending on the surface finish after the first machining step, the second machining step is optional. The precision surface may advantageously optimize, for example, the tribological properties of the surface. Another advantage may be an enhancement of the resistance of the surface to oxidation. Such machining for producing precision surfaces may, merely by way of example, be used in the case of a fiber composite component assembly that includes a fiber-reinforced ceramic composite, also known as ceramic matrix composite (CMC).

The inventive fiber composite component system may include a tolerance compensation layer having a joining surface. The joining surface may, in particular, be a mechanically machined planar, even and/or planarized joining surface. The joining surface is designed in particular for joining to a further component.

In some specific embodiments, the subsurface fibers are cut at and/or within; i.e., at a distance from the edge of, the, in particular planar, joining surface of the tolerance compensation layer and/or fibers or fiber segments terminate there. This may be caused by previous mechanical machining including removal of material. Since the demands on the tolerance compensation layer in terms of loads, especially tensile loads in the fiber direction, may be considerably less in comparison to the underlying component, it may be that, unlike the underlying component, cut fibers in the tolerance compensation layer may be acceptable.

The inventive fiber composite component system may include a fiber composite component assembly and/or a further component having an overlap portion in an area or areas thereof. For example, an end portion, an edge, or another portion of a fiber composite component and/or of a further component may include an overlap portion for joining these two components. The overlap portion may be used, for example, for material-to-material bonding. For example, for purposes of adhesive bonding, the surface of the overlap region may be pretreated to create a secure and firm adhesive bond.

The fiber composite component system according to the present invention may include a further component that is made from or includes a metallic material in the region of the joining surface.

### BRIEF DESCRIPTION OF THE DRAWINGS

The present invention will now be described, by way of example only, with reference to the accompanying drawings, in which identical or similar components are indicated by the same reference numerals. The figures show in greatly simplified schematic form in:

FIG. 1 a cross-sectional view of an inventive fiber composite component system including a fiber composite component assembly according to the present invention and an attached flange;

FIG. 2 a cross-sectional view of an inventive fiber composite component assembly having a tolerance compensation layer before and after mechanical machining; and

FIG. 3 a cross-sectional view of an inventive fiber composite component assembly having a tolerance compensation layer that includes a fiber composite portion and a further layer portion.

### DETAILED DESCRIPTION

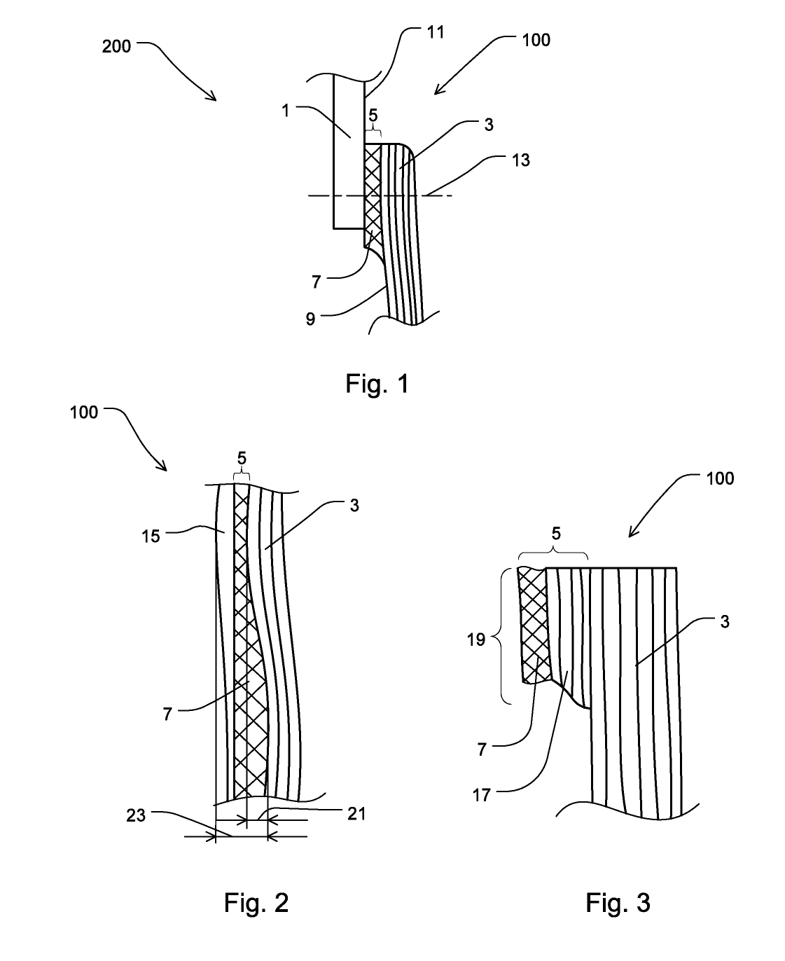

FIG. 1 shows, in cross-sectional view, an inventive fiber composite component system 200 including a fiber composite component assembly 100 according to the present invention and an attached flange 1. Flange 1 may be referred to as a further component.

Fiber composite component assembly 100 includes a fiber composite component 3 and a tolerance compensation layer 5. Fiber composite component 3 is illustrated by a number of nearly parallel lines, which represent the individual fibers in a base material. The fibers may, for example, have an individual diameter of several μm. The fibers may be glass fibers, carbon fibers, ceramic fibers, aramid fibers, boron fibers, basalt fibers, steel fibers, natural fibers, nylon fibers or other fibers. The fibers may contribute significantly to the strength of fiber composite component 3. The base material may be referred to as a substrate or matrix. Polymers such as, for example, thermosetting polymers (other names: thermosetting plastics, synthetic resins), elastomers and thermoplastics are often used as the base material.

In this specific embodiment, tolerance compensation layer 5 includes a further layer portion 7 that compensates for the uneven surface 9 of fiber composite component 3 and the smooth surface 11 of flange 1. Further layer portion 5 may be, for example, a sprayed layer. Further layer portion 5 may, merely by way of example, be a polymer or include a polymer. Alternatively, further layer portion 5 may be composed of a different material, be a composite material, for example one including a polymer. After applying further layer portion 5 to uneven surface 9 of fiber composite component 3, further layer portion 5 may, in a subsequent machining step, be machined on the side that is to be joined to the flange. This machining may be mechanical machining by milling, another material-removal method, such as a laser ablation process, or any other method. This machining step may optionally be followed by one or more further steps, for example for smoothing, polishing or surface treatment. A surface treatment may be a plasma process to prepare for a subsequent adhesive bonding step.

Flange 1 may also be machined on the side that is to be joined to fiber composite component assembly 100, for example by milling, polishing, etc.

The connection between flange 1 and tolerance compensation layer 5, which, in this embodiment, exemplarily takes the form of a further layer 7, may be a material-to-material bond, for example an adhesive bond or a weld.

In this specific embodiment, the connection between flange 1 and fiber composite component assembly 100 is accomplished by means of two end regions or overlap regions of the two mentioned components. Thus, tolerance compensation layer 5 has been applied to fiber composite component 3 only in the region of this overlap.

The connection of the individual components is indicated by a connecting line 13. As an alternative to a material-to-material bond, the connection may be a force-fit connection or a form-fitting connection or a combination of a material-to-material bond, a force-fit connection and a form-fitting connection. Merely by way of example, the connection may be screwed or riveted.

FIG. 2 shows, in cross-sectional view, an inventive fiber composite component assembly 100 having a tolerance compensation layer 5 before and after, in particular mechanical, machining. Before machining, tolerance compensation layer 5 additionally includes removal layer 15, which has an uneven surface (to the left in FIG. 2). In the specific embodiment shown here, the surface is undulated or wavy. Removal layer 15 is reduced to its final surface shape using a material-removal process, such as a milling process. This final surface shape is dependent on the surface shape of the component to which fiber composite component assembly 100 is to be joined. If this component has, for example, a smooth surface, the shape of tolerance compensation layer 5 may be adapted accordingly.

The shape of removal layer 15 may be referred to as a layer contour before an exemplary mechanical machining operation.

The wavy shape of fiber composite component 3 may be due to the manufacturing process. Material removal directly from the surface of fiber composite component 3; i.e., without tolerance compensation layer 5, could damage the subsurface fibers in fiber composite component 3 and significantly weaken the strength of the component.

The maximum profile depth 21 of the wavy surface of fiber composite component 3 is less than the maximum thickness 23 of tolerance compensation layer 5. Thus, fiber composite component 3, in particular its subsurface layers including fibers of the fiber composite material, may remain unmachined or undamaged when material is removed from removal layer 15 by mechanical machining.

FIG. 3 shows, in cross-sectional view, an inventive fiber composite component assembly 100 having a tolerance compensation layer 5 that includes a fiber composite portion 17 and a further layer portion 7.

The fiber composite portion 17 is, merely by way of example, configured as an integral portion that forms as a unit with the fiber composite component 3 in terms of material. Thus, the fibers of fiber composite portion 17 as well as the base material of fiber composite portion 17 may be identical to those of fiber composite component 3. The fibers of fiber composite portion 17, which are shown as vertical, nearly parallel lines, preferably extend only over joint region 19. These fibers are not needed for structurally stabilizing fiber composite component assembly 100 outside the joint region 19. The fibers of fiber composite portion 17 do not form a structural unit with the fibers of fiber composite component 3. Therefore, if no further layer 7 were applied (not shown in FIG. 3), this fiber composite portion 17 could be mechanically machined and at least partially removed without affecting or weakening the structural stability and strength of fiber composite component 3. The fibers of fiber composite component 3 may extend beyond the joint region and, for example, follow or define a curved component contour.

Further layer portion 7 may be a sprayed layer. The corresponding descriptions for FIGS. 1 and 2 may be considered analogously.

### LIST OF REFERENCE NUMERALS

100 fiber composite component assembly
200 fiber composite component system
1 flange; further component
3 fiber composite component
5 tolerance compensation layer
7 further layer portion
9 surface; uneven surface
11 surface; smooth surface
13 connecting line
15 removal layer
17 fiber composite portion
19 joint region; region of the joining surface
21 maximum profile depth
23 thickness of the tolerance compensation layer

1-15. (canceled)

16. A fiber composite component assembly comprising:
a fiber composite component including a base material and a fiber material; and
a tolerance compensation layer for joining the fiber composite component to a further component, the tolerance compensation layer including a fiber composite portion or a further layer portion.

17. The fiber composite component assembly as recited in claim 16 wherein the tolerance compensation layer includes a tolerance compensation layer base material the same as the base material, at least in some regions.

18. The fiber composite component assembly as recited in claim 16 wherein the tolerance compensation layer includes a tolerance compensation layer fiber material the same as the fiber material at least in some regions.

19. The fiber composite component assembly as recited in claim 16 wherein the tolerance composition layer includes the fiber composite portion and wherein a structural unit of the fiber composite component and a further structural unit of the fiber composite portion of the tolerance compensation layer are different.

20. The fiber composite component assembly as recited in claim 16 wherein the fiber composite component and the tolerance compensation layer are integrally joined together, at least in some regions.

21. The fiber composite component assembly as recited in claim 16 wherein the tolerance composition layer includes the further layer portion, the further layer portion being a sprayed layer or includes a sprayed layer.

22. The fiber composite component assembly as recited in claim 16 wherein the tolerance compensation layer includes the fiber composite portion and the further layer portion and wherein the further layer portion is joined to the fiber composite portion by a material-to-material bond.

23. The fiber composite component as recited in claim 16 wherein the tolerance composition layer includes the further layer portion, the further layer portion being joined to the fiber composite component by a material-to-material bond.

24. The fiber composite component assembly as recited in claim 16 wherein a thickness of the tolerance compensation layer is greater than a maximum profile depth of surface irregularities of the fiber composite component.

25. A fiber composite component system comprising the fiber composite component assembly as recited in claim 16 and a further component joined to the fiber composite component assembly.

26. The fiber composite component system as recited in claim 25 wherein the tolerance compensation layer of the fiber composite component assembly has a joining surface for joining to the further component.

27. The fiber component system as recited in claim 26 wherein fibers or fiber segments terminate with the joining surface of the tolerance compensation layer.

28. The fiber component system as recited in claim 26 wherein the joining surface is a mechanically machined planar or planarized joining surface.

29. The fiber composite component system as recited in claim 26 wherein the fiber composite component assembly or the further component has an overlap portion.

30. The fiber composite component system as recited in claim 26 wherein the further component is made from or includes a metallic material in a region of the joining surface.

31. A method for producing the fiber composite component system as recited in claim 25, the method comprising the following steps:
providing a fiber composite component assembly including a fiber composite component including a base material and a fiber material and a tolerance compensation layer for joining the fiber composite component to a further component, the tolerance compensation layer including a fiber composite portion or a further layer portion;
machining the tolerance compensation layer in such a manner that the surface contour of the to-be-joined surface of the further component is adapted to the tolerance compensation layer;
joining the fiber composite component assembly to the further component via the adapted tolerance compensation layer.

32. The method as recited in claim 31 wherein the machining of the tolerance compensation layer is accomplished by removal of material or results in the provision of a plane joining surface.
